(19) United States
(12) Patent Application Publication
(10) Pub. No.: US 2005/0164884 A1
(43) Pub. Date: Jul. 28, 2005

(54) Use of a solvent/antifoam substance mixture in aqueous formulations and resulting formulations

(76) Inventors: Valerio Bramati, Arese (IT); Alessandro Chiovato, Lyon (IT)

Correspondence Address: Jean Louis Seugnet;Intellectual Property Department, Rhodia Inc CN 7500, 259 Prospect Plains Road, Cranbury, NJ, 08512-7500, US

(21) Appl. No.: 10/503,805

(22) PCT Filed: Feb. 6, 2003
(86) PCT No.: PCT/FR03/00376

(30) Foreign Application Priority Data
Feb. 6, 2002 (FR) 02/01513
Apr. 9, 2002 (FR) 02/04467

(51) Int. Cl. A01N 57/18; A01N 25/04; A01N 25/16

(52) U.S. Cl. 504/206; 504/364; 510/241

(57) ABSTRACT

The invention relates to the application, in an aqueous formulation, of a mixture comprising at least one solvent and at least one substance having antifoam properties in aqueous medium; the solvent/substance weight ratio is between 99.95/0.05 and 90/10; said solvent is chosen from those for which, in all or part of the range of the abovementioned weight ratio, the mixture is homogeneous, and from those for which the aqueous formulation, comprising from 0.01 50 5% by weight of mixture, is homogeneous.

The subject of the present invention is the use of a mixture comprising a solvent and a substance having antifoam properties in aqueous formulations.

In numerous fields using aqueous formulations, it is necessary to control the level of foam produced, or even to avoid its appearance, this being even more critical if the formulations comprise a relatively high content of surfactants. These compounds not only promote the appearance of foam but also enhances its stability.

There are various reasons for wishing to achieve such a result.

For example, the appearance of a more or less stable foam, in an excessively large quantity can cause difficulties during the manufacture and/or the packaging of formulations, resulting in a loss of productivity at this (these) stage(s) of production.

Foam can also be a problem when it appears during the use of the formulations. In this case, it can be the cause of overflowing of tanks, of difficulties during the application of the formulation with in particular poor operation of the pumps used. Foam can also cause uncontrolled and large variations in the viscosity of the formulation. Moreover, in the case of cement formulations used in the field of building materials or of the exploitation of oil or gas deposits, the appearance of foam can be the cause of a reduction in the performance of the formulation, the reduction in performance due to the presence of air bubbles trapped in the formulation during setting.

Apart from the difficulties mentioned above, the phenomenon of foaming can prove to be dangerous in applications linked to the cleaning of platforms. Indeed, not only can the platforms be made slippery but also the appearance of foam in the well itself, during the cleaning operation of the latter before it goes into production, has the consequence of reducing the density in the well (by inclusion of air) and can, for example, cause uncontrolled eruption of petroleum if it involves a gusher.

In order to solve these disadvantages linked to the appearance of foam with certain aqueous formulations, the use of substances having antifoam properties has been developed. However, in many cases, said antifoam substances are not substances soluble in aqueous medium. Thus, it is possible to observe phenomena of incompatibility with the formulation, which can cause for example demixing or precipitation, thereby limiting the efficacy of such substances.

The document WO 00/17266 describes an antifoam mixture comprising 70% by weight of a solvent and 30% by weight of an antifoam agent. This mixture has beneficial effects in the context of a use in weakly basic compositions for washing gas, in particular for removing toxic gases such as H₂S or CO₂. These mixtures are found to be advantageous in antifoam performance in these compositions. However, they are not advantageous in aqueous formulations which are desired to be homogeneous and/or sufficiently stable during storage, in the presence of certain compounds.

In some cases, such as that of aqueous formulations intended for the treatment of plants, there has been put in place the use of additional additives introduced by the user during the use of the plant-protection formulation (tank-mix). More particularly, numerous plant-protection formulations exist in a concentrated form which the user must dilute beforehand, in which dilution step it is possible to observe the appearance of a large quantity of foam upon application to the plant to be treated. It is during this which is very often stable. Thus, it is during this step that it is proposed to introduce the antifoam agent. However, this solution is not completely satisfactory in the sense that it requires the use of several products which have to be measured out and stored.

Moreover, if these conventional additional additives, which are usually fluorinated silicones or metal salts of fatty acids, are added to the concentrated aqueous formulation, the latter is not homogeneous and phase separation is observed during its storage.

It therefore still remains desirable to find additives which could be incorporated into an aqueous formulation, whether it is in concentrated or dilute form, without observing destabilization of the whole, and which would have antifoam and/or defoaming properties during the dilution and/or use of the aqueous formulation.

The subject of the present invention is the use, in an aqueous formulation, of a mixture comprising at least one solvent and at least one substance having antifoam properties in aqueous medium; the solvent/substance weight ratio being between 99.95/0.05 and 90/10; said solvent being chosen from those for which, in all or part of the range of the abovementioned weight ratio, the mixture is homogeneous, and from those for which the aqueous formulation, comprising from 0.01 to 5% by weight of mixture, is homogeneous.

Another subject of the invention consists of an aqueous formulation comprising from 0.01 to 5% by weight of a mixture comprising at least one solvent and at least one substance having antifoam properties in aqueous medium; the solvent/substance weight ratio being between 99.95/0.05 and 90/10; said solvent being chosen from those for which, in all or part of the range of the abovementioned weight ratio, the mixture is homogeneous, and from those for which the aqueous formulation, comprising from 0.01 to 5% by weight of mixture, is homogenous.

This mixture provides a solution to the problem of foaming which appears during the manufacture, dilution and use of the formulation. It has indeed been observed, completely unexpectedly, that the use of this type of mixture made it possible to destabilize the foam which appears when the content of antifoam agent present in the formulation is low.

It has been observed, unexpectedly, that a synergy exists, which can be observed at two levels, between the solvent and the associated antifoam substance.

The first level is that of the performance achieved. Thus, in the case where the antifoam substance is not compatible with the aqueous formulation, it is observed, for identical concentrations (1% by weight of the formulation), that the defoaming or antifoam phenomenon is greater for aqueous formulations comprising the abovementioned mixture than for aqueous formulations comprising only the solvent or only the antifoam substance. It is specified that an aqueous formulation comprising 1% of noncompatible antifoam substance in aqueous medium is of course not stable over time. Consequently, if the concentrated formulation is diluted immediately after preparation, the antifoam effect is indeed observed. However, this effect cannot be maintained in the short term (that is after storage) unless the formulation is perfectly rehomogenized, which represents a serious constraint which it is not always possible to carry out.

The second level is that of the content of antifoam substance present in the aqueous formulation. Thus, the results obtained with the mixture used in the context of the invention were obtained with antifoam substance contents of the order of 0.01% in the formulation, or even less.

Finally, the formulation comprising the mixture according to the invention, whether in dilute or nondilute form, is stable during storage unlike formulations comprising contents of the order of 1% as antifoam substance.

However, other advantages and characteristics of the present invention will emerge more clearly on reading the description and the example which follows.

In the text which follows, the term “mixture” will be used for the combination of the solvent and of the antifoam substance used in the context of the invention.

It is furthermore specified, in the text which follows, that the terms antifoam and defoaming will be used interchangeably.

As was indicated above, the mixture used according to the invention comprises at least one solvent, and at least one substance having antifoam properties in aqueous medium, the solvent/substance weight ratio being between 99.95/0.05 and 90/10. This ratio is preferably-between 99.95/0.05 and 95/5, and still more preferably between 99.95/05 and 98/2.

The solvent is chosen from those for which, in all or part of the range of abovementioned weight ratio, the mixture is homogeneous. Furthermore, the solvent is chosen from those for which the aqueous formulation, comprising from 0.01 to 5% by weight of mixture, is homogeneous.

The term homogeneous means that no decantation or macroscopic phase separation is observed either for the solvent/antifoam substance mixture, or for the mixture/aqueous formulation combination, at 20° C., one hour after being brought into contact.

Among the suitable solvents, there may be mentioned:
esters of saturated or unsaturated, linear or branched mono- or dicarboxylic acids comprising 2 to 15 carbon atoms, optionally comprising an alkoxy group, preferably a methoxy group, or a hydroxyl group, and of a saturated or unsaturated, linear or branched monoalcohol or polyol comprising 1 to 13 carbon atoms;
the mono-, di- and/or triester phosphates for which the radical(s), which are identical or different, are linear or branched alkyl radicals bearing 2 to 12 carbon atoms;
ketones for which the radicals, which are identical or different, are linear or branched alkyl radicals comprising 1 to 5 carbon atoms;
heterocyclic derivatives comprising at least one nitrogen and/or at least one oxygen and/or at least one sulfur;
mono- or polyethers of polyalcohols;
   alone or as a mixture.

As regards the esters of carboxylic acids, the latter are more particularly chosen from esters of acetic, caprylic, octanoic, decanoic, dodecanoic, lauric and lauroleic acids, alone or as mixtures.

In the case where the acid is a dicarboxylic acid, preferably the two carboxyl functional groups are in esterified form.

Moreover, the alcohol from which the ester is formed is preferably a monoalcohol.

It will be no departure from the present invention to use the products derived from alcoholysis (more particularly methanolysis, ethanolysis) of triglycerides of animal origin or preferably of plant origin. By way of examples of suitable triglycerides, there may be mentioned peanut oil, cottonseed oil, linseed oil, olive oil, palm oil, grapeseed oil, soybean oil, castor oil, rapeseed oil, copra oil, coconut oil.

As regards the phosphate esters, the latter correspond more particularly to the following formula: (RO)ₙP(═O)(OM)₃₋ₙ; in which R, which are identical or not, represent a saturated or unsaturated, linear or nonlinear C₁-C₁₈, preferably C₂-C₁₂, hydrocarbon radical; n is an integer between 1 and 3; M, which are identical or not, represent a hydrogen atom, an alkali or alkaline-earth metal, a radical of the N(R′)₄⁺ type for which the radicals R′, which are identical or different, represent a hydrogen atom or a saturated or unsaturated, linear or nonlinear C₁-C₆ hydrocarbon radical optionally substituted with a hydroxyl group.

There may be mentioned in particular mono-, di- and tributyl phosphates, alone or as a mixture.

Among the suitable ketones, there may be mentioned acetone, methyl ethyl ketone, methyl isobutyl ketone, alone or as a mixture.

As regards the heterocyclic derivatives, comprising at least one nitrogen and/or one oxygen and/or one sulfur, suitable in particular are N-methylpyrrolidone, tetrahydrofuran, dioxane and the like; N-methylpyrrolidone being preferred.

As for the mono- or polyethers of polyalcohols, they are preferably such that the ether part(s) comprise one or more alkyl radicals comprising from 1 to 4 carbon atoms. As for the part derived from the polyalcohol, the latter is preferably of the polyethylene glycol type. By way of example, there may be mentioned methyl diglycol.

Preferably, the solvent used is chosen from esters of mono- or dicarboxylic acids or the heterocyclic derivatives.

The substance having antifoam properties in aqueous medium may be chosen from all the compounds having this type of properties.

However, according to a first advantageous embodiment of the present invention, said substance is chosen from silicones.

More particularly, said silicone substances may comprise, in addition to silicon, oxygen, carbon and hydrogen atoms, halogen atoms or nitrogen atoms.

However, advantageously, the silicone substances used are chosen from those comprising or consisting of units of formula
R′₃₋ₐRₐSiO_{1/2} and R₂SiO_{2/2}
in which formulae
a is an integer from 0 to 3
the radicals R are identical or different and represent
a saturated or unsaturated aliphatic hydrocarbon group containing from 1 to 10 carbon atoms;
a polar organic group attached to the silicon by a Si—C or Si—O—C bond;
an aromatic hydrocarbon group containing from 6 to 13 carbon atoms;
the radicals R′ are identical or different and represent
an OH group;
an alkoxy or alkenyloxy group containing from 1 to 10 carbon atoms;
an aryloxy group containing from 6 to 13 carbon atoms;
an acyloxy group containing from 1 to 13 carbon atoms;
a cetiminoxy group containing from 1 to 8 carbon atoms;
an amino or amido functional group containing from 1 to 6 carbon atoms, attached to the silicon by an Si—N bond;
   preferably at least 80% of the radicals R of said oils, gums or resins representing a methyl group.

Among the polyorganosiloxane resins which may be used, there may be mentioned those consisting of units of formula
RSiO_{3/2}(T unit) and/or SiO₂(Q unit) combined with units of formula
R′₃₋ₐRₐSiO_{1/2}(M unit) and/or R₂SiO_{2/2}(D unit) in which formulae a, R and R′ have the definition given above.

These are generally of the MQ, MDQ, TDM, TD, MT type.

By way of examples of aliphatic or aromatic hydrocarbon radicals R, there may be mentioned:
alkyl groups such as methyl, ethyl, octyl, trifluoropropyl
alkoxyalkylene groups such as —CH₂—CH₂—O—CH₃; —CH₂—CH₂—O—CH₃
alkenyl groups such as vinyl, alkyl, hexenyl, decenyl, decadienyl
alkenyloxyalkylene groups such as —(CH₂)₃—O—CH₂—CH═CH₂; —(CH₂)₃—OCH₂—CH₂—O—CH═CH₂
aryl groups such as phenyl.

By way of examples of polar organic groups R, there may be mentioned:
hydroxy functional groups such as —(CH₂)₃—OH; —(CH₂)₄N (CH₂CH₂OH)₂; —(CH₂)₃—N(CH₂CH₂OH)—CH₂—CH₂—N(CH₂CH₂OH)₂
amino functional groups such as —(CH₂)₃—NH₂; —(CH₂)₃—NH—(CH₂)₂NH₂
amido functional groups such as —(CH₂)₃—N—(COCH₃)—(CH₂)₂NH(COCH₃)
carboxyl functional groups such as —CH₂—CH₂—S—CH₂—COOH.

By way of examples of radicals R′, there may be mentioned:
alkoxy groups such as methoxy, ethoxy, octyloxy
alkenyloxy groups such as vinyloxy, hexenyloxy, isopropenyloxy
aryloxy groups such as phenyloxy
acyloxy groups such as acetoxy
cetiminoxy groups such as ON═C(CH₃)C₂H₅
amino functional groups such as ethylamino, phenylamino
amido functional groups such as methylacetamido.

By way of concrete examples of “D units”, there may be mentioned: (CH₃)₂SiO; CH₃(CH═CH₂)SiO; CH₃(C₆H₅)SiO; (C₆H₅)₂SiO; CH₃HSiO; CH₃(CH₂—CH₂—CH₂OH)SiO.

By way of concrete examples of “M units”, there may be mentioned: (CH₃)₃SiO_{1/2}; (CH₃)₂(OH)SiO_{1/2;} (CH₃)₂(CH═CH₂) SiO_{1/2}; (CH₃)₂HSiO_{1/2}; (OCH₃)₃SiO_{1/2}; [O—C(CH₃)═CH₂]₃SiO_{1/2}; [ON═C(CH₃)]₃SiO_{1/2}; (NH—CH₃)₃SiO₁₂; (NH—CO—CH₃)₃SiO_{1/2}.

By way of concrete examples of “T units”, there may be mentioned CH₃SiO_{3/2}; (CH═CH₂)SiO_{3/2}; HSiO_{3/2}.

When said oils, gums or resins contain reactive and/or polar radicals R (such as H, vinyl, allyl, hexenyl, aminoalkyls), the latter generally do not represent more than 2% of the weight of the oil or of gum and not more than 10% of the weight of the resin.

The viscous polydimethylsiloxane and α,ω-bis(hydroxy)polydimethylsiloxane oils and the polydimethylsiloxane, polyphenylmethylsiloxane and α,ω-bis(hydroxy)polydimethylsiloxane gums are well known, commercial products.

The viscous polymethylsiloxane resins DT containing from 1 to 2% by weight of silanol functional groups are also commercial products.

The silicone substances may comprise at least one filler, in particular an inorganic filler. In this case, the compositions are called compounds. The silicone substance/filler ratios range in particular from 2 to 15, preferably from 2 to 10.

The inorganic filler is preferably silica.

It may be precipitated silica or fumed silica, treated or not.

The precipitated silica is preferably prehydrophobized by conventional treatment with one or more organosilicon compounds. It may also be incorporated untreated, and then treated (hydrophobized) in situ with one or more organosilicon compounds. Among these compounds are methylpolysiloxanes such as hexamethyldisiloxane, octamethylcyclotetrasiloxane, methylpolysilazanes such as hexamethyldisilazane, hexamethylcyclotrisilazane, chlorosilanes such as dimethyldichlorosilane, trimethylchlorosilane, methylvinyldichlorosilane, dimethylvinylchlorosilane, alkoxysilanes such as dimethylmethoxysilane. During this treatment, the silicas can increase their initial weight up to a level of 20%.

The fumed silica may be used untreated. If necessary, it can however be treated like the precipitated silica.

It is also possible to use in addition to or in place of the siliceous fillers other inorganic fillers such as ground quartz, calcined clay and diatomaceous earth.

The inorganic fillers generally have a specific surface area, measured according to the BET methods, of at least 50 m²/g, in particular of between 50 and 400 m²/g, preferably of greater than 70 m²/g, a mean particle size of less than 0.1 micrometer (μm) and an apparent density of less than 200 g/liter.

In addition to the filler described above, the silicone substance may comprise at least one surfactant, which is preferably nonionic.

By way of suitable nonionic surfactants, there may be mentioned for example:
alkoxylated fatty alcohols, more particularly comprising from 6 to 22 carbon atoms;
alkoxylated mono-, di- and triglycerides;
alkoxylated fatty acids, more particularly comprising from 6 to 22 carbon atoms;
alkoxylated sorbitan esters, in particular cyclized sorbitol esters of fatty acids comprising from 10 to 20 carbon atoms;
alkoxylated fatty amines, more particularly comprising from 6 to 22 carbon atoms;
alkoxylated alkylphenols, more particularly comprising one or two linear or branched alkyl groups having 4 to 12 carbon atoms;
alkyl polyglucosides; alone or as mixtures.

If the surfactant is present, its content is advantageously from 5 to 10% by weight relative to the weight of the silicone substance and, where appropriate, of the filler.

According to a second embodiment of the present invention, the substance having antifoam properties is chosen from perfluoroalkylphosphonic acids, perfluoroalkylphosphinic acids, perfluoroalkylphosphoric acids, or their alkali metals or ammonium salts.

More particularly, the alkyl radicals comprise 6 to 18 carbon atoms.

The salts may be salts of alkali metals, such as sodium or potassium, but also of ammonium of formula NR₄⁺; in which formula R, which are identical or different, represent a hydrogen atom, an alkyl radical comprising 1 to 18 carbon atoms, optionally bearing at least one hydroxyl or amine group which is optionally ethoxylated.

These products are known to persons skilled in the art and are described in particular in patent U.S. Pat. No. 5,332,714.

According to the invention, the solvent/substance weight ratio is between 99.95/0.05 and 90/10, preferably between 99.8/0.2 and 98/2.

Moreover, the aqueous formulation comprises 0.01 to 5% by weight of mixture (solvent/substance), preferably 0.1 to 2% by weight of the aqueous formulation.

It should be noted that depending on the fields of application, the aqueous formulations may be used either as such, or after dilution.

The aqueous formulations comprising the mixture described above can have numerous applications.

Thus, these formulations can be used in the field of the exploitation of oil or gas deposits, as cementation fluid, as drilling fluid, or even as fracturing fluid.

Drilling fluids are conventionally fluids whose rheological properties are of the rheofluidizing type.

Generally, the fluids comprise polysaccharides such as galactomannans, such as guar; natural or chemically modified (partially or completely deacetylated and/or depyruvylated) xanthan gum or alternatively xanthan gum obtained after genetic modification of the strain producing it.

The polysaccharide content is usually between 0.01 and 2% by weight relative to the total weight of the drilling fluid.

The drilling fluid further comprises salts which are soluble or at least partially soluble in the fluid, inorganic and optionally organic acids.

Among the salts of inorganic acids, there may be mentioned alkali or alkaline-earth metal halides, such as sodium, potassium or magnesium chloride or bromide. It is likewise possible to use alkali or alkaline-earth metal sulfates, carbonates, bicarbonates, silicates or phosphates alone or as a mixture.

Among the salts of organic acids, there may be mentioned most especially alkali or alkaline-earth metal formates, or alkali or alkaline-earth metal acetates.

It is likewise possible to use a salt chosen from silicates, preferably those for which the Na₂O/SiO₂ molar ratio is close to 1/2, optionally combined with the salts mentioned above.

The salt content is more particularly between 5000 and 110 000 ppm.

The drilling fluid may also comprise a filtrate control reducer or filtrate reducer.

By way of examples of this type of compounds, there may be mentioned cellulosic compounds (in particular carboxymethylcelluloses, hydroxyethylcelluloses), polyacrylamides, polyacrylates of high molecular weight, succinoglycans, native starch or its derivatives, charcoal.

The quantity of filtrate reducer greatly depends on the nature of the rocks traversed while remaining nondetrimental because these compounds have, for the most part, a Newtonian rheological profile. As a guide, the quantity of filtrate reducer is less than or equal to 1% relative to the total weight of the fluid.

The drilling fluids may also comprise fluidizing or dispersing agents, such as polyphosphates, tannins, lignosulfonates, lignin derivatives, peats and lignites, polynaphthalene sulfonates, alone or as a mixture.

The quantity of fluidizing or dispersing agent is variable but generally remains less than or equal to 1% relative to the total weight of the fluid.

The drilling fluid according to the invention may additionally comprise an oxygen scavenger so as to avoid any degradation of some additives. For example, hydroxylamines, hydrazine, sulfites, bisulfites, hydrosulfites, and borohydrides are suitable oxygen scavengers.

Generally, the content of additive of this type is less than or equal to 0.25%.

The drilling fluid may furthermore comprise a weighting compound and/or at least one inorganic colloid.

The weighting components contribute toward maintaining a sufficient hydrostatic pressure in the well and toward maintaining in suspension the rocks carried during the drilling operation. Such compounds are conventionally chosen from the soluble salts mentioned above and the sparingly or very sparingly soluble salts, such as alkaline-earth metal sulfates, silicates or carbonates, of the barium sulfate or calcium carbonate type. It is likewise possible to use alkaline-earth metal or zinc bromides such as potassium bromide or zinc bromide.

The inorganic colloids, which are compounds substantially insoluble under the conditions for using the fluid, are agents modifying the rheology of the medium and making it possible to maintain the debris in suspension in the latter. Attapulgite, barite, bentonite, alone or as a mixture, are the most common examples thereof.

Other additives may be used, such as inorganic salts promoting the precipitation of divalent ions, compounds limiting the swelling of clays, free radical transfer agents, biocides, anticorrosion agents and the like.

As regards the cementation fluids used for cementation of wells, the latter comprise a hydraulic binder.

Compounds capable of reacting and hardening when they are in the presence of water may be used; they are conventionally compounds based on silicon, aluminum, calcium, oxygen and/or sulfur. For example, compounds based on calcium silicate (Portland cement), pozzolana, gypsum, hydraulic binders with high aluminum content, hydraulic binders based on phosphate and hydraulic binders based on calcium silicate, are preferred.

It should be noted that the cementation fluid may comprise conventional additives in the field, such as for example filtrate reducing agents, caking retardants or accelerants, dispersant agents, rheology modifiers, thickening agents, air carrying agents, agents preventing the migration of gases, and the like.

Usually, the total content of these additives, when they are present, does not exceed 30% by weight of hydraulic binder.

The cementation fluid may additionally comprise fillers. By way of nonlimiting examples of inorganic fillers which may be used, there may be mentioned calcium carbonate, fly ash, silica, fumed silica, clays (kaolin, metakaolin, bentonite, sepiolite, wollastonite), mica, feldspar, silicate, glass, titanium dioxide, aluminum or magnesia.

Expanded polystyrene may be used in particular as organic filler.

The mean size of inorganic fillers is advantageously less than or equal to 120 μm, preferably less than or equal to 80 μm.

The content of fillers in the cement, when they are present, varies according to the subsequent applications for which the cement is intended. Likewise, depending on whether it is desired to make the latter denser or lighter, inorganic or organic fillers may be used.

Here again, without intending to be limiting thereto, the content of fillers represents at most the same weight as the hydraulic binder.

It should be noted that the cementation fluid may comprise long or short reinforcing fibers. These fibers may be either metallic or polymeric. Advantageously, the polymeric fibers are polyamide, polyvinyl alcohol, polyethylene or polypropylene fibers, and the like. The size of the reinforcing fibers may vary within a broad range. By way of example, the size can vary between a few tenths of millimeter to several tens of millimeter.

As for the content of fluid in these fibers, it can be easily evaluated by a person skilled in the art. It is usually less than or equal to 10% relative to the hydraulic binder.

The cement, mortar and concrete compositions, and the like, intended for the building materials industry may likewise comprise the mixture according to the invention.

Such compositions are of the same type as those which have just been described above in the context of the cementing of wells.

They may also comprise granular components which are usually chosen from sand, silicon dioxide, titanium, alumina, talc, mica, (meta)kaolin, bentonite, clinker, vermiculite, perlite, cellulose, slag. They may be crystallized or amorphous synthetic products obtained for example by grinding, and sieving to the desired size.

It is also possible to use ground silica, pyrogenic silica and fly ash.

The particle size distribution of the granular components can vary widely depending on the application envisaged. The size of the granular components can vary for example between 1 and 500 μm.

According to another possibility, the aqueous formulations comprising the mixture can be used in the paper industry.

They can be used in particular as paper coating bath.

The formulations comprise pigment-type fillers. They may be inorganic pigments such as kaolin, white satin, talc, calcium carbonate, titanium oxide, inter alia, or alternatively plastic pigments.

The formulation further comprises binders, whether they are of the natural type, such as starches, or of the synthetic type, such as latexes.

Generally, the latexes are obtained from unsaturated monomers such as vinyl, acrylic or vinylaromatic monomers, vinyl esters, alkyl esters of unsaturated acids, esters of unsaturated carboxylic acids, vinyl chloride, vinylidene chloride and/or dienes. Among the suitable latexes, there may be mentioned styrene/butadiene, styrene/acrylate and styrene/butadiene/acrylate latexes, and the like.

Usually, the binders are present in an amount of 5 to 25 parts by weight per 100 parts by weight of pigment.

The formulations may likewise comprise an optical brightener, in an amount of 0.1 to 0.7 parts by weight, preferably combined with an optical brightener carrier such as polyvinyl alcohol with a content usually of between 0.2 and 2 parts by weight.

The formulations preferably comprise a thickening agent. Such compounds make it possible to control the rheology of the formulation. This may include alkali-soluble copolymers comprising a combination of several monomers such as carboxylated ethylenically unsaturated compounds, nonionic vinyl monomers and monomers and ethylenically unsaturated nonionic amphiphilic monomers.

The formulations may also comprise slip agents such as calcium stearate, and insolubilizing agents.

Usually, dry matter content of the formulation is 60 to 75% by weight.

According to certain applications, the compositions for a coating bath may also comprise resins such as epoxy resins, provided in the form of an emulsion.

These resins may be chosen in particular from aromatic epoxy resins of the Novolak type, epoxy resins of the bisphenol-A type.

The emulsions additionally comprise a nonionic surfactant, such as polyethylene and/or polypropylene oxides, alkylaromatic ethers of polyethylene and/or polypropylene glycol, polyoxyalkylene derivatives of hexitol including sorbitans and mannitans.

The mixture according to the invention may likewise be used in formulations intended for making laminated compounds, in which formulations melamine-formalin or urea-formalin resins are present; and in formulations for adhesive compositions.

The aqueous formulations comprising the solvent/substance mixture can even be used in the field of deformation or transformation of metals, such as in particular operations of wiredrawing and rolling, for deformation, and cutting work, for transformation.

The aqueous formulations conventionally used are provided in concentrated form which the user dilutes before carrying out the working of the metal.

The solvent/substance mixture may be used in aqueous formulations of this type.

Among the products capable of entering into the composition of such formulations are saturated or unsaturated carboxylic acids comprising at least 5 carbon atoms. More particularly, these acids are chosen from saturated or unsaturated mono- or polycarboxylic acids comprising 5 to 40 carbon atoms. By way of example, there may be mentioned palmitic, behenic, stearic, palmitoleic, oleic, petroselenic, erucic, linoleic, linolenic and ricinoleic acids, alone or as mixtures.

Said acid may optionally be in a form neutralized with an inorganic base (alkali metal hydroxides, hydroxycarbonates and (bi)carbonates, and the like, aqueous ammonia) or an organic base (primary, secondary or tertiary amines optionally substituted with one or more OH radicals, or an alkoxylated radical).

The formulations may even comprise acid phosphate esters having at least one saturated or unsaturated aliphatic, cycloaliphatic or aromatic hydrocarbon radical containing 1 to 30 carbon atoms, which is optionally polyalkoxylated (polyoxyethylenated and/or polyoxypropylenated).

The formulations may comprise, where appropriate, a nonionic surfactant in an amount of 5% maximum relative to the total weight of the formulation after dilution, such as polyalkoxylated alkylphenols, polyalkoxylated C₈-C₂₂ aliphatic alcohols, polyalkoxylated triglycerides, and the like).

The aqueous formulations may furthermore be used in the field of cleaning and/or degreasing surfaces. The expression cleaning surfaces is understood to mean the cleaning of textiles (laundry) and the cleaning of hard surfaces, in particular dishes, domestic surfaces, and industrial surfaces. The formulations for cleaning textile surfaces may be laundry detergents for washing by hand or in a machine. The formulations for washing dishes may be products for washing dishes by hand or in a machine. In these formulations, it is often desirable to control foaming. Moreover, there is great interest in homogeneous, or even transparent, formulations.

The aqueous formulations for degreasing sheet metals are preferably alkaline formulations.

As a guide, the content of mixture during the use of these formulations, which are often in dilute form, is of the order of 0.01 to 5 g/l.

They additionally comprise:
of the order of 0 to 2%, generally 0.01 to 1% by weight (in the aqueous formulation) of at least one anionic or nonionic detergent surfactant such as (C₈-C₁₆)alkylbenzenesulfonates, (C₈-C₂₀)alkyl sulfates, ethoxylated alkylphenols, ethoxylated fatty alcohols, block polymers of ethylene oxide and propylene oxide,
of the order of 5 to 20% by weight (in an aqueous formulation) of at least one hydrotropic electrolyte such as benzenesulfonates, mono- or di(C₁-C₄)alkylbenzenesulfonates, toluene-, xylene- or cumene-sulfonates,
other hydrotropic agents, such as alcohols and glycols,
of the order of 5 to 25% by weight (in the aqueous formulation) of at least one sequestering agent such as nitriloacetic acid, ethylenediaminetetraacetic acid, ethylenediaminetetramethylphosphonic acid, nitrilotrimethylenephosphonic acid and their salts,
buffering agents such as alkanolamines, ethylenediamine and the like.

In the field of petroleum oil exploitation, and more particularly of the degreasing of platforms, the aqueous formulations comprise of the order of 0.005 to 0.05 g/l, preferably of the order of 0.015 to 0.025 g/l of the formulation (after dilution) as a mixture.

The aqueous compositions used for degreasing oil platforms may comprise, in addition to the solvent/substance mixture:
of the order of 0 to 2%, generally 0.01 to 1% by weight (in the aqueous formulation) of at least one anionic or nonionic detergent surfactant such as (C₈-C₁₆)alkylbenzenesulfonates, (C₈-C₂₀)alkyl sulfates, ethoxylated alkylphenols, ethoxylated fatty alcohols, block polymers of ethylene oxide and propylene oxide,
of the order of 5 to 20% by weight (in the aqueous formulation) of at least one hydrotropic electrolyte such as benzenesulfonate, mono- or di(C₁-C₄)alkylbenzenesulfonates, toluene-, xylene- or cumene-sulfonates,
other hydrotropic agents, such as alcohols and glycols,
at least one pH-regulating agent such as for example alkali metal carbonates, sesquicarbonates and bicarbonates,
additives such as enzymes in a quantity which may be up to 5% of the total weight of the aqueous fluid, and metal corrosion inhibitors.

The aqueous formulations used for cleaning oil wells comprise, in addition to the mixture:
3 to 40% by weight of the aqueous medium of anionic surfactants (alkyl ester sulfonates, alkyl sulfates, salts of C₈-C₂₄ fatty acids, saturated or unsaturated, C₉-C₂₀ alkylbenzenesulfonates, alkyl sulfonates, and the like), nonionic surfactants (polyoxyalkylenated alkylphenols, polyoxyalkylenated C₈-C₂₂ aliphatic alcohols, products resulting from the condensation of ethylene oxide, the compound resulting from the condensation of propylene oxide with propylene glycol, and the like);
an agent allowing the pH to be adjusted, such as for example alkali metal carbonates, sesquicarbonates and bicarbonates, alkali or alkaline-earth metal hydroxides,
additives such as enzymes in a quantity which may be up to 5% of the total weight of the aqueous fluid, and metal corrosion inhibitors,
if necessary, weighting agents so as to maintain a sufficient hydrostatic pressure in the well. Reference may be made to the list given in the context of the description of the constituent elements of drilling fluids;
hydrocolloids such as polysaccharides of plant origin, such as polygalactomannans and their derivatives, such as guar, hydroxypropylguar; cellulose and its derivatives, starches and their derivatives; polysaccharides of bacterial origin such as xanthan gum or deacetylated derivatives.

The aqueous formulations may also be used in the field of water paints, or coatings.

Paints, in addition to the mixture according to the invention, comprise in general a binder and at least one additional component chosen from fillers, pigments, surfactants, thickeners, antioxidants, natural binders, dispersing agents, biocides, and the like.

Usually, the binders are latexes prepared from unsaturated ethylenic monomers.

Among the appropriate monomers, there may be mentioned most especially styrene, butadiene, acrylic esters and vinyl nitrites.

It is likewise possible to include, during the preparation of said latexes, unsaturated ethylenic monomers having a crosslinkable character such as glycidyl (meth)acrylate or vinyl and acrylic silanes. If they are present, their content generally does not exceed 0.1 to 5% of the unsaturated ethylenic monomers mentioned above.

The particle size of the latexes is more particularly between 100 and 500 nm.

Furthermore, it is possible to combine the latex with a nanolatex whose size is between 5 and 40 nm.

These nanolatexes may be homopolymers or copolymers containing units derived from vinyl, acrylic or vinylaromatic monomers, vinyl esters, alkyl esters of unsaturated acids, esters of unsaturated carboxylic acids, vinyl chloride, vinylidene chloride and/or dienes.

Moreover, the latex binder is preferably neutralized with a base (for example aqueous ammonia or an amine).

The composition further comprises pigments such as zinc or titanium dioxide, zinc sulfides, iron oxides, molybdates or chromates, and the like.

It may even comprise calcium carbonates, talc, baryta, silica, mica, diatomaceous earths, and the like.

The content of these compounds is determined in a conventional manner in the field, so as to obtain good covering properties and good mechanical properties. As a guide, their content varies between 10 and 50% by volume.

In accordance with another embodiment of the invention, the aqueous formulations may be intended for the treatment of plants.

Advantageously, the formulations are in the form of concentrated solutions.

They comprise, moreover, at least one plant-protection active material, which is soluble and stable (that is to say which is not substantially hydrolyzed) in aqueous medium, at the chosen concentration.

By way of example, the concentration of active material(s) in the formulation is less than or equal to 540 g/l expressed relative to the active material, more particularly between 100 and 540 g/l, preferably between 100 and 500 g/l. It should be noted that when the active material is present in salified form, the ranges which have just been indicated are expressed relative to the active material in nonsalified form.

According to a preferred embodiment of the invention, the plant-protection active materials are chosen from hydrophilic pesticides, and more especially herbicides, but also hydrophilic nutritive elements promoting the growth and development of plants.

Preferably, said active materials are in the form of organic or inorganic salts.

Among the suitable active materials, there may be mentioned in particular the following herbicidal active materials in the form of organic or inorganic salts: aminophosphate or aminophosphonate derivatives, Acifluorfen, Asulam, Bentazon, Bialaphos, Bispyribac, Bromacil, Bromoxynil, Chloramben, Clopyralid, 2,4-D, 2,4-Db, Dalapon, Dicamba, Dichloprop, Difenzoquat, Diquat, Endothall, Fenac, Fomesafen, Fosamine, Ioxynil, MCPA, MCPB, Mecoprop, Methylarsonic Acid, Naptalam, Paraquat, Picloram, Sulfamic Acid, alone or as a mixture.

Preferably, the active material is chosen from aminophosphate or aminophosphonate derivatives, in the form of organic or inorganic salts, such as glyphosate, sulphosate, glufosinate, in the form of organic or inorganic salts.

The expression glyphosate denotes more particularly N-phosphonomethylglycine and any derivative thereof leading in aqueous solution to glyphosate anions.

As suitable salts, there may be mentioned more particularly the salts of alkali metals such as sodium or potassium; ammonium salts, of the N(R)₄⁺ type for which the radicals R, which are identical or different, represent a hydrogen atom or saturated or unsaturated, linear or nonlinear C₁-C₆ hydrocarbon radical optionally substituted with a hydroxyl group; or alternatively sulfonium salts; said salts being present alone or in combination.

Among the ammonium salts, there may be mentioned most particularly secondary or primary amines such as isopropylamine, dimethylamine or diamines such as ethylenediamine; amines bearing a hydroxyl group such as monoethanolamine. As for the sulfonium salts, trimethylsulfonium is perfectly suitable.

As preferred glyphosate derivatives, there may be mentioned in particular the isopropylamine salt and the trimethylsulfonium salt.

As regards the nutritive elements, they are preferably metal salts such as zinc, iron and preferably manganese salts. These salts are used in the form of chelates of the EDTA type for example or of sulfates.

According to one variant of the invention, the plant-protection formulation comprises at least one biological activator of the plant-protection active material.

By way of examples of biological activators, there may be mentioned in particular polyalkoxylated amines (more especially comprising at least one hydrocarbon radical having from 4 to 30 carbon atoms) and in particular polyethoxylated amines; polyalkoxylated (for example polyethoxylated or polyethoxylated/polypropoxylated) amidoamines. Also suitable are the polyalkoxylated (for example polyethoxylated or polyethoxylated/polypropoxylated) mono- and diphosphate esters of saturated or unsaturated, linear or nonlinear aliphatic hydrocarbon alcohols comprising more particularly 4 to 30 carbon atoms, or of aromatic alcohols (more particularly those for which the aromatic ring comprises 6 carbon atoms) optionally comprising one or more substituents on the aromatic ring, chosen from alkyl radicals, alkenyl radicals, comprising up to 30 carbon atoms, or chosen from alkylaryl radicals for which the linear or nonlinear alkyl part comprises 1 to 10 carbon atoms and the aryl part comprises 6 carbon atoms; the counterion is generally chosen from alkali metals such as sodium or potassium, ammonium ions of the NR₄⁺ type with R, which are identical or different, representing a hydrogen atom, an alkyl radical comprising 1 to 10 carbon atoms, preferably 1 to 4, optionally bearing a hydroxyl radical.

Among the biological activators which can be envisaged, there may also be mentioned inorganic salts which are soluble in the aqueous phase, such as for example the salts of alkali metals, such as sodium or potassium, or of ammonium of the compounds chosen from carbonates; bicarbonates; halides, such as chlorides, fluorides; nitrates, phosphates; hydrogen phosphates; sulfates; bisulfates; bisulfides, alone or as a mixture.

The activators which have just been mentioned may be used alone or as mixtures.

It should be noted furthermore that the quantity of biological activator generally represents 10 to 70% by weight relative to the plant-protection active material(s), preferably between 20 and 60% by weight.

Finally, a final subject of the invention consists of an aqueous formulation comprising from 0.01 to 5% by weight of a mixture comprising at least one solvent and at least one substance having antifoam properties in aqueous medium; the solvent/substance weight ratio being between 99.95/0.05 and 90/10; said solvent being chosen from those for which, in all or part of the range of weight ratio mentioned above, the mixture is homogeneous and from those for which the aqueous formulation, comprising from 0.01 to 5% by weight of mixture, is homogeneous.

What was detailed above in relation to the nature of the various constituent elements of the mixture and their contents remains valid and will not be described again.

In addition, the formulations comprise the customary additives, depending on the fields in which they are used. Here again, reference may be made to the appropriate passages of the description.

The formulations are quite obviously obtained by mixing the components constituting them.

A concrete but nonlimiting example of the invention will now be presented.

### EXAMPLE

A plant-protection formulation is prepared which comprises glyphosate in the form of an isopropylamine salt, and whose glyphosate concentration is 360 g/l expressed as acid equivalent, by mixing the following compounds, with stirring:

| | |
|---|---|
| Isopropylamine salt of | 360 g/l expressed as |
| glyphosate | glyphosate in acid form |
| Tallow amine comprising | 170 g/l |
| 15 EO | |
| Water | qs 1 liter |

In the control trial, the foam test is performed on the formulation described above, without adding antifoaming/defoaming agent.

The trial according to the invention is a formulation as described above comprising 1% of a 99/1 mixture by weight respectively of Phytorob® 810.01 (comprising a mixture of C₈-C₁₀ methyl esters and marketed by the company Novance) and Rhodorsil® 481 (marketed by the company Rhodia Chimie). The formulation obtained is clear and stable during storage. Such a mixture is marketed in particular by the company Rhodia under the name Geronol CF/AR.

The foam test (CIPAC MT 47, foam persistence, Cipac Handbook F page 152) is as follows:
0.5 ml of the composition to be tested is added to a graduated cylinder with 50 ml of water (Cipac D water).

The cylinder is stoppered and 30 complete inversions are made, allowing on each inversion the air bubble to rise to the top part.

The cylinder is unstoppered and the foam volume is measured at 10 seconds, 1 minute, 3 minutes and 12 minutes.

The table below gives the foam volume in ml for each of the trials, at the times mentioned:

| | Time | | | |
|---|---|---|---|---|
| | 1 second | 1 minute | 3 minutes | 12 minutes |
| Control | 50 | 39 | 16 | 5 |
| Invention | 29 | 8 | 5 | 3 |

A formulation comprising 1% of Rhodorsil® 481, without solvent, is cloudy and is not stable during storage.

A formulation comprising 1% of Phytorob® 810.01, without Rhodorsil® 481, is clear and stable during storage. On the other hand, the level of defoaming is much less high than that obtained with the mixture according to the invention.

1-21. (canceled)

22. A process for providing antifoam properties to an aqueous formulation, comprising the step of adding to said formulation an efficient amount of a mixture comprising at least one solvent and at least one substance having antifoam properties in aqueous medium; with a solvent/substance weight ratio being between 99.95/0.05 and 90/10; said solvent being chosen from those for which, in all or part of the range of the abovementioned weight ratio, the mixture is homogeneous, and from those for which the aqueous formulation, comprising from 0.01 to 5% by weight of mixture, is homogeneous.

23. The process as claimed in claim 22, wherein the solvent is:
an ester of saturated or unsaturated, linear or branched mono
or dicarboxylic acids comprising 2 to 15 carbon atoms, optionally comprising an alkoxy group, preferably a methoxy group, or a hydroxyl group, and of a saturated or unsaturated, linear or branched monoalcohol or polyol comprising 1 to 13 carbon atoms;
a mono-, di- and/or triester phosphate for which the radical(s), which are identical or different, are linear or branched alkyl radicals bearing 2 to 12 carbon atoms;
a ketone for which the radicals, which are identical or different, are linear or branched alkyl radicals comprising 1 to 5 carbon atoms;
a heterocyclic derivative comprising at least one nitrogen and/or at least one oxygen and/or at least one sulfur; or
a mono- or polyethers of polyalcohols.

24. The process as claimed in claim 22, wherein the substance having antifoam properties is a silicone comprising units of formulae:
R′₃₋ₐRₐSiO_{1/2} and R₂SiO_{2/2}
wherein:
a is an integer from 0 to 3 the radicals R are identical or different and represent a saturated or unsaturated aliphatic hydrocarbon group containing from 1 to 10 carbon atoms;
a polar organic group attached to the silicon by a Si—C or Si—O—C bond; or an aromatic hydrocarbon group containing from 6 to 13 carbon atoms;
the radicals R′ are identical or different and represent an OH group;
an alkoxy or alkenyloxy group containing from 1 to 10 carbon atoms;
an aryloxy group containing from 6 to 13 carbon atoms;
an acyloxy group containing from 1 to 13 carbon atoms;
a cetiminoxy group containing from 1 to 8 carbon atoms; or an amino or amido functional group containing from 1 to 6 carbon atoms, attached to the silicon by an Si—N bond;
optionally, at least 80% of the radicals R representing a methyl group.

25. The process as claimed in the preceding claim 22, wherein the silicone substance comprises at least one filler.

26. The process as claimed in claim 25, wherein the silicone substance presents a silicone substance/filler weight ratio from 2 to 15, optionally from 2 to 10.

27. The process as claimed in claim 22, wherein the silicone substance further comprises at least one surfactant, which is optionally nonionic.

28. The process as claimed in claim 27, wherein the surfactant has a content from 5 to 10% by weight relative to the weight of the silicone substance and, optionally, of filler.

29. The process as claimed in claim 22, wherein the substance having antifoam properties is a perfluoroalkylphosphonic acid, perfluoroalkylphosphinic acid, perfluoroalkylphosphoric acids or their alkali metal or ammonium salts.

30. The process as claimed in claim 22, wherein the solvent presents a solvent/substance weight ratio of between 99.8/0.2 and 98/2.

31. The process as claimed in claim 22, wherein 0.01 to 5% by weight of the mixture is added to the aqueous formulation, optionallly 0.1 to 2%.

32. The process as claimed in claim 22, wherein the aqueous formulations is to be used in the field of the exploitation of oil or gas deposits.

33. The process as claimed in claim 22, wherein the aqueous formulation is to be used in the paper industry.

34. The process as claimed in claim 22, wherein the aqueous formulation is to be used in the field of the deformation or the transformation of metals.

35. The process as claimed in claim 22, wherein the aqueous formulation is to be used in the field of the cleaning and/or the stripping of surfaces.

36. The process as claimed in claim 22, wherein the aqueous formulation is to be used in the field of water paints, coatings, laminates or adhesives.

37. The process as claimed in claim 22, wherein the aqueous formulation is to be used in the field of building materials.

38. The process as claimed in claim 22, wherein the aqueous formulation is to be used for the treatment of plants.

39. The process as claimed in the claim 38, wherein the aqueous formulation comprises at least one plant-protection active material which is an aminophosphate or an aminophosphonate, in the form of organic or inorganic salts.

40. The process as claimed in the claim 39, wherein the plant-protection active material is a glyphosate, sulfosate, or a glufosinate, in the form of organic or inorganic salt.

41. The process as claimed in claim 40, wherein the plant-protection active material is present in the formulation in a concentration of less than or equal to 540 g/l, expressed relative to the nonsalified active material.

42. The process as claimed in claim 41, wherein said concentration is between 100 and 540 g/l.

43. The process as claimed in claim 40, wherein the formulation further comprises at least one biological activator of the plant-protection active material.

44. An aqueous formulation comprising from 0.01 to 5% by weight of a mixture comprising at least one solvent and at least one substance having antifoam properties in aqueous medium; with a solvent/substance weight ratio being between 99.95/0.05 and 90/10; said solvent being chosen from those for which, in all or part of the range of the abovementioned weight ratio, the mixture is homogeneous, and from those for which the aqueous formulation, comprising from 0.01 to 5% by weight of mixture, is homogeneous.
